(19) United States
(12) Patent Application Publication
(10) Pub. No.: US 2005/0175896 A1
(43) Pub. Date: Aug. 11, 2005

(54) Hydrogen-absorbing alloy for alkaline storage batteries, alkaline storage battery, and method of manufacturing alkaline storage battery

(76) Inventors: Jun Ishida, Kobe-city (JP); Shigekazu Yasuoka, Kobe-city (JP)

Correspondence Address: KUBOVCIK & KUBOVCIK, SUITE 710, 900 17TH STREET NW, WASHINGTON, DC, 20006, US

(21) Appl. No.: 11/052,905

(22) Filed: Feb. 9, 2005

(30) Foreign Application Priority Data
Feb. 10, 2004 (JP) 2004-032982

(51) Int. Cl. H01M 4/58; H01M 4/32; C01B 6/24

(52) U.S. Cl. 429/218.2; 29/623.1; 429/223; 420/900

(57) ABSTRACT

An alkaline storage battery includes a positive electrode (1) a negative electrode (2), and an alkaline electrolyte solution. The negative electrode uses a hydrogen-absorbing alloy powder containing at least a rare-earth element, Mg, Ni, and Al, and has an intensity ratio I_{A}/I_{B} of 0.1 or greater in X-ray diffraction analysis using Cu—Kα radiation, where I_{A} is the strongest peak intensity that appears in the range of 2θ=31 to 33°, and I_{B} is the strongest peak intensity that appears in the range of 2θ=40 to 44°. When the alkaline storage battery is activated, the condition M1/M2≦0.18 is satisfied, where M1 is a Mg concentration in a region of particles of the hydrogen-absorbing alloy powder within 30 nm from the surface thereof and M2 is a Mg concentration in an inner region of the hydrogen-absorbing alloy particles in which the oxygen concentration is less than 10 weight %.

### BACKGROUND OF THE INVENTION

1. Field of the Invention

This invention relates to hydrogen-absorbing alloys for alkaline storage batteries, alkaline storage batteries, and methods of manufacturing alkaline storage batteries. Particularly, a feature of this invention is to control deterioration of the hydrogen-absorbing alloy caused by reaction with an alkaline electrolyte solution and thereby to improve the cycle life of the alkaline storage battery in the case of using a hydrogen-absorbing alloy powder for the negative electrode of an alkaline storage battery to increase the battery capacity, where the hydrogen-absorbing alloy powder contains at least a rare-earth element, magnesium, nickel, and aluminum and has an intensity ratio I_{A}/I_{B} of 0.1 or greater in X-ray diffraction analysis using Cu—Kα radiation as an X-ray source, where I_{A} is the strongest peak intensity that appears in the range 2θ=31° to 33° and I_{B} is the strongest peak intensity that appears in the range 2θ=40° to 44°.

2. Description of Related Art

Conventionally, nickel-cadmium storage batteries have been commonly used as alkaline storage batteries. In recent years, nickel-metal hydride storage batteries using a hydrogen-absorbing alloy as a material for their negative electrode have drawn considerable attention from the viewpoints that they have a higher capacity than nickel-cadmium storage batteries and, being free of cadmium, they are more environmentally safe.

As the nickel-metal hydride storage batteries have been increasingly used in various portable devices, further improved performance in the nickel-metal hydride storage batteries have been demanded.

In the nickel-metal hydride storage batteries, hydrogen-absorbing alloys such as a rare earth-nickel hydrogen-absorbing alloy having a CaCu₅ crystal structure as its main phase and a Laves phase hydrogen-absorbing alloy containing Ti, Zr, V and, Ni have been generally used for their negative electrodes.

However, these hydrogen-absorbing alloys generally do not necessarily have sufficient hydrogen-absorbing capability, and it has been difficult to further increase the capacity of the nickel-metal hydride storage batteries.

In recent years, it has been proposed to use a powder of a hydrogen-absorbing alloy that contains a rare-earth element, magnesium, and nickel, and has high hydrogen-absorbing capability (see, for example, Japanese Unexamined Patent Publication Nos. 11-323469 and 2002-69554).

Nevertheless, the use of such hydrogen-absorbing alloy powder as described above for the negative electrode of an alkaline storage battery has caused the following problem. As the battery is charged and discharged repeatedly, deterioration of the hydrogen-absorbing alloy powder occurs due to oxidization by the alkaline electrolyte solution, and the alkaline electrolyte solution is gradually consumed in the alkaline storage battery, increasing the resistance in the alkaline storage battery. This shortens the cycle life of the alkaline storage battery.

Accordingly, it is an object of the present invention to resolve the foregoing and other problems in an alkaline storage battery employing, for the negative electrode, a hydrogen-absorbing alloy containing a rare-earth element, magnesium, and nickel and having a high hydrogen absorbing capability.

Specifically, it is an object of the invention to improve the cycle life of an alkaline storage battery by preventing the hydrogen-absorbing alloy used for the negative electrode from deterioration caused by oxidation by the alkaline electrolyte solution and controlling an increase of the internal resistance of the alkaline storage battery caused by gradual consumption of the alkaline electrolyte solution.

### BRIEF SUMMARY OF THE INVENTION

In order to resolve the foregoing and other problems, the invention provides an alkaline storage battery comprising: a positive electrode employing nickel hydroxide, a negative electrode employing a hydrogen-absorbing alloy powder, and an alkaline electrolyte solution; wherein said negative electrode employs a hydrogen-absorbing alloy powder containing at least a rare-earth element, magnesium, nickel, and aluminum, and having an intensity ratio I_{A}/I_{B} of 0.1 or greater in X-ray diffraction analysis using Cu—Kα radiation as an X-ray source, where I_{A} is a strongest peak intensity that appears in the range of 2θ=31° to 33° and I_{B} is a strongest peak intensity that appears in the range of 2θ=40° to 44°; and wherein, when the alkaline storage battery is activated, the condition M1/M2≦0.18 is satisfied, where M1 is the magnesium concentration in a region of the particles of the hydrogen-absorbing alloy powder within 30 nm from the surface and M2 is the magnesium concentration in an inner region of the hydrogen-absorbing alloy particles in which the oxygen concentration is 10 weight % or less.

It should be noted that the phrase “when the alkaline storage battery is activated” means to charge and discharge an alkaline storage battery as manufactured to obtain a desired capacity in the alkaline storage battery.

Here, it is preferable that the hydrogen-absorbing alloy, which contains at least a rare-earth element, magnesium, nickel, and aluminum and has an intensity ratio I_{A}/I_{B} of 0.1 or greater in X-ray diffraction analysis using Cu—Kα radiation as an X-ray source, where I_{A} is the strongest peak intensity that appears in the range of 2θ=31° to 33° and I_{B} is the strongest peak intensity that appears in the range of 2θ=40° to 44°, have a Ce₂Ni₇-type crystal structure. The hydrogen-absorbing alloy having a Ce₂Ni₇-type crystal structure is capable of absorbing a large amount of hydrogen, thus increasing the capacity of the alkaline storage battery; on the other hand, the hydrogen-absorbing alloy has a low corrosion resistance and therefore deteriorates as the charge-discharge process proceeds, leading to a short cycle life of the battery. Nevertheless, by configuring the hydrogen-absorbing alloy in the above-described manner, the deterioration due to the charge-discharge process can be controlled, and thus, the cycle life can be improved while a high capacity is ensured. The particles of the hydrogen-absorbing alloy powder have an average particle diameter of at least 2 μm.

Moreover, when the hydrogen-absorbing alloy powder contains lanthanum as a rare-earth element, it is preferable that a lanthanum concentration L1 at the surface of particles of the hydrogen-absorbing alloy powder and a minimum lanthanum concentration L2 in a region thereof within 50 nm from the surface satisfy the condition L1/L2≧1.9. When a layer having a lower lanthanum concentration than the lanthanum concentration at the surface of particles of the hydrogen-absorbing alloy powder exists in the region within 50 nm from the surface, the speed of absorbing hydrogen is high because of the surface at which the lanthanum concentration is high, and moreover, the layer in which the lanthanum concentration is low functions as a protective layer, controlling the deterioration inside particles of the hydrogen-absorbing alloy powder during the charge-discharge process.

If the magnesium concentration at the surface of the hydrogen-absorbing alloy particles is reduced greatly so that the condition M1/M2≦0.18 is satisfied, where the magnesium concentration M1 is in the region of the hydrogen-absorbing alloy particles that is within 30 nm from the surface and the magnesium concentration M2 is in the inner region thereof in which the oxygen concentration is less than 10 weight %, in a state in which the alkaline storage battery has been activated, the surface of the hydrogen-absorbing alloy in which the magnesium concentration is reduced greatly is oxidized, forming a dense protective layer. For this reason, even when the alkaline storage battery is repeatedly charge and discharged, the protective layer controls deterioration of the hydrogen-absorbing alloy particles caused by the oxidation of the inner region thereof by an alkaline electrolyte solution. The protective layer also hinders the magnesium in the inner region of the hydrogen-absorbing alloy particles from being eluted therefrom. Thus, a decrease in the discharge capacity can be prevented.

In satisfying the condition M1/M2≦0.18 when the alkaline storage battery has been activated, where M1 is the magnesium concentration in the region of particles of the hydrogen-absorbing alloy powder that is within 30 nm from the surface and M2 is the magnesium concentration in an inner region thereof in which the oxygen concentration is less than 10 weight %, an alkaline storage battery employing the above-described hydrogen-absorbing alloy may be activated by setting it aside until the battery voltage becomes equal to or above −18 mV with respect to the maximum voltage obtained when the alkaline storage battery is set aside before initially charging the battery; and thereafter performing a charge-discharge process.

When an alkaline storage battery is set aside until the battery voltage becomes equal to or above −18 mV with respect to the maximum voltage obtained when the alkaline storage battery is set aside before initially charging the battery, the magnesium in the surface of the hydrogen-absorbing alloy particles gradually is eluted therefrom, forming a layer having a low magnesium concentration in the surface of the hydrogen-absorbing alloy particles. Thereafter, when the alkaline storage battery has been activated by charging and discharging, the magnesium concentration M1 in the region of the particles of the hydrogen-absorbing alloy powder that is within 30 nm from the surface and the magnesium concentration M2 in an inner region of the hydrogen-absorbing alloy particles in which the oxygen concentration is less than 10 weight % satisfy the condition M1/M2≦0.18. Also, the surface of the hydrogen-absorbing alloy particles in which the magnesium concentration becomes low is oxidized, forming a dense protective layer.

In setting an alkaline storage battery aside until the battery voltage becomes equal to or above −18 mV with respect to the maximum voltage that is obtained when the alkaline storage battery is set aside before initially charging the battery, the alkaline storage battery should be set aside in a predetermined temperature range for a predetermined duration. It should be noted that if the temperature at which the alkaline storage battery is set aside is too high, the components constituting the battery may deteriorate due to the heat. On the other hand, if the temperature at which the alkaline storage battery is set aside is too low, the time for setting aside the battery before initially charging the battery becomes too long. Therefore, it is preferable that the battery be set aside in a temperature range of from 25° C. to 80° C.

In setting the alkaline storage battery aside until the battery voltage becomes equal to or above −18 mV with respect to the maximum voltage before initially charging the battery, for example, the alkaline storage battery may be set aside for 48 hours or longer if the battery is set aside at a temperature of 25° C.; or alternatively, if the alkaline storage battery is set aside at a temperature condition of 45° C., the battery may be set aside for 8 hours or longer. It should be noted that when the time for setting aside is too long, the productivity for the alkaline storage batteries considerably decreases. Therefore, the time for setting the battery aside should be within 240 hours.

The hydrogen-absorbing alloy used for the alkaline storage battery may be any hydrogen-absorbing alloy as long as it contains at least a rare-earth element, magnesium, nickel, and aluminum. However, it is preferable to use, for example, a hydrogen-absorbing alloy represented by the general formula Ln₁₋ₓMgₓNi_{y-a}Alₐ (wherein Ln is at least one element selected from rare-earth elements, 0.05≦x<0.20, 2.8≦y≦3.9, and 0.10≦a≦0.25) in order to increase the capacity and improve the cycle life. In the hydrogen-absorbing alloy represented by the foregoing general formula, it is more preferable to use a hydrogen-absorbing alloy in which a portion of the rare-earth element Ln or the Ni is substituted by at least one element selected from the group consisting of V, Nb, Ta, Cr, Mo, Mn, Fe, Co, Ga, Zn, Sn, In, Cu, Si, P, and B.

Although the nickel hydroxide used for the positive electrode in the alkaline storage battery is not particularly limited, it is preferable to use a nickel hydroxide of which the surface is coated with a cobalt oxide in which the cobalt valence is higher than 2, in order to control deterioration of the positive electrode when the alkaline storage battery is repeatedly charged and discharged, as in the case of the negative electrode.

As described above, in this invention, the negative electrode of an alkaline storage battery employs a hydrogen-absorbing alloy powder containing at least a rare-earth element, magnesium, and nickel, and having an intensity ratio I_{A}/I_{B} of 0.1 or greater in X-ray diffraction analysis using Cu—Kα radiation as an X-ray source, where I_{A} is the strongest peak intensity that appears in the range of 2θ=31° to 33° and I_{B} is the strongest peak intensity that appears in the range of 2θ=40° to 44°, and, therefore, the capacity of the alkaline storage battery increases.

Moreover, according to the invention, when the alkaline storage battery has been activated, the magnesium concentration M1 and the magnesium concentration M2 satisfy the condition M1/M2≦0.18, where M1 is the magnesium concentration in a region of the particles of the hydrogen-absorbing alloy powder that is within 30 nm from the surface and M2 is the magnesium concentration in an inner region of the hydrogen-absorbing alloy particles in which the oxygen concentration is 10 weight % or less. Therefore, even when the alkaline storage battery is repeatedly charged and discharged, oxidation of the inner region of the hydrogen-absorbing alloy particles is controlled, and the elution of the magnesium from the inner region of the hydrogen-absorbing alloy particles is controlled. Thus, a decrease in the discharge capacity is prevented, and the cycle life of the alkaline storage battery is improved.

### BRIEF DESCRIPTION OF THE DRAWINGS

FIG. 1 is a schematic cross-sectional view illustrating an alkaline storage battery as fabricated in Examples 1 and 2, and Comparative Example 1 of the invention; and

FIG. 2 is a graph illustrating the changes in battery voltage when the above-described alkaline storage battery is set aside at temperatures of 25° C. and 45° C. before the battery is activated.

### DETAILED DESCRIPTION OF THE PREFERRED EMBODIMENTS

Hereinbelow, preferred embodiments are described of a hydrogen-absorbing alloy for alkaline storage batteries, a method of manufacturing the same, and an alkaline storage battery according to the present invention. A comparative example is also described to demonstrate that the alkaline storage battery according to the embodiments of the invention can improve the cycle life of the alkaline storage battery by controlling the deterioration of the particles of the hydrogen-absorbing alloy powder used for the negative electrode, which is caused by oxidation to the inner region of the particles. It should be construed, however, that the hydrogen-absorbing alloy for alkaline storage batteries, the method of manufacturing the same, and the alkaline storage battery according to the invention are not limited to those illustrated in the following embodiments, and various changes and modifications may be made without departing from the scope of the invention.

### Examples 1 and 2, and Comparative Example 1

In each of Examples 1 and 2, and Comparative Example 1, a negative electrode was prepared using Mg, Ni, Al, and Co in addition to rare-earth elements La, Pr, Nd, and Zr. These were mixed to produce a predetermined alloy composition, thereafter melted in an argon atmosphere, and cooled. Thus, a hydrogen-absorbing alloy ingot was prepared. The composition of the hydrogen-absorbing alloy ingot resulted in (La_{0.2}Pr_{0.395}Nd_{0.395}Zr_{0.01})_{0.83}Mg_{0.17}Ni_{3.03}Al_{0.17}CO_{0.1}.

Then, the hydrogen-absorbing alloy ingot was annealed to make it uniform in quality, and thereafter mechanically pulverized in an inert atmosphere. The pulverized alloy was classified to obtain powder of the hydrogen-absorbing alloy having a volume average particle size of 65 μm.

The hydrogen-absorbing alloy powder thus prepared was subjected to X-ray diffraction analysis. The X-ray diffraction analysis was carried out with the use of an X-ray diffraction analyzer using Cu—Kα radiation as an X-ray source (RINT2000 system, made by Rigaku Corp.) at a scan speed of 2°/min. and a scan step of 0.02° in a scan range of 20° to 80°. A strongest peak intensity (I_{A}) that appears at 32.8°, which is within the range of 2θ=31° to 33°, and a strongest peak intensity (I_{B}) that appears at 42.2°, which is within the range of 2θ=40° to 44°, were measured to obtain an intensity ratio (I_{A}/I_{B}) Thus, it was found that the intensity ratio I_{A}/I_{B} was 0.51, and the main phase of the hydrogen-absorbing alloy had a Ce₂Ni₇-type crystal structure, i.e., a different crystal structure from a CaCu₅ type.

Then, 0.5 parts by weight of polyvinyl pyrrolidone and 0.5 parts by weight of polyethylene oxide as binder agents in addition to 20 parts by weight of water were added to 100 parts by weight of the hydrogen-absorbing alloy powder, and these were kneaded to prepare a paste.

The paste was applied uniformly to both sides of a conductive core made of punched metal, which was then dried and pressed. Thereafter, the resultant was cut into predetermined dimensions to prepare a negative electrode composed of a hydrogen-absorbing alloy electrode.

To prepare a positive electrode, nickel hydroxide powder containing 2.5 weight % of zinc and 1.0 weight % of cobalt was put into an aqueous solution of cobalt sulfate, and 1 mole of an aqueous solution of sodium hydroxide was gradually dropped into the mixture with stirring to cause the components to react with each other at a pH of 11. Thereafter, the resulting precipitate was filtered, washed with water, and vacuum dried. Thus, nickel hydroxide in which 5 weight % of cobalt hydroxide was coated on the surface was obtained.

Then, a 25 weight % aqueous solution of sodium hydroxide was added and impregnated to the nickel hydroxide coated with cobalt hydroxide at a weight ratio of 1:10, and the resultant was annealed at 85° C. for 8 hours with stirring; thereafter, this was washed with water and dried to obtain a positive electrode material in which the surface of the nickel hydroxide was coated with sodium-containing cobalt oxide. In the cobalt oxide, the cobalt valence was 3.05.

Then, 95 parts by weight of the positive electrode material thus prepared, 3 parts by weight of zinc oxide, and 2 parts by weight of cobalt hydroxide were mixed, and to the mixture, 50 parts by weight of an aqueous solution of 0.2 weight % hydroxypropylcellulose was added and mixed together to prepare a slurry. The slurry was filled into a nickel foam having a weight per unit area of 600 g/m², a porosity of 95%, and a thickness of about 2 mm. The resultant was dried and pressed, and thereafter cut into predetermined dimensions. Thus, a positive electrode composed of a non-sintered nickel electrode was prepared.

A nonwoven fabric made of polypropylene was used as a separator. An alkaline electrolyte solution containing KOH, NaOH, and LiOH at a weight ratio of 15:2:1 and having a specific gravity of 1.30 was used as an alkaline electrolyte solution.

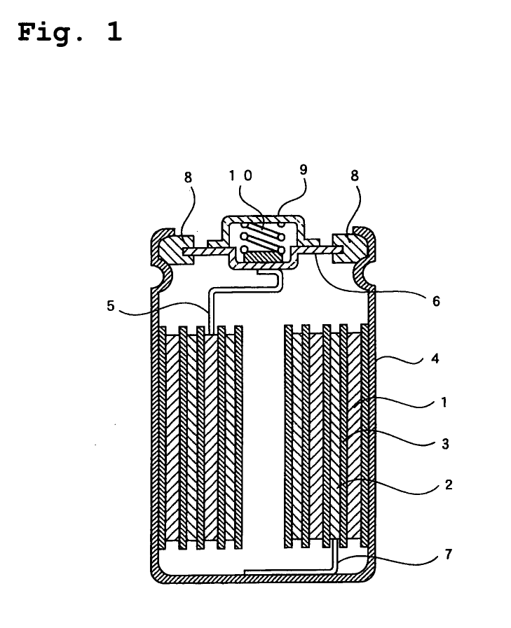

To prepare an alkaline storage battery, a positive electrode 1 and a negative electrode 2, prepared in the foregoing manner, were spirally coiled with a separator 3 interposed therebetween as illustrated in FIG. 1, and these were accommodated in a battery can 4. Then, 2.4 g of the alkaline electrolyte solution was poured into the battery can 4. Thereafter, an insulative packing 8 was placed between the battery can 4 and a positive electrode cap 6, and the battery can 4 was sealed. The positive electrode 1 was connected to the positive electrode cap 6 through a positive electrode lead 5, and the negative electrode 2 was connected to the battery can 4 through a negative electrode lead 7. The battery can 4 and the positive electrode cap 6 were electrically insulated by the insulative packing 8. A coil spring 10 was placed between the positive electrode cap 6 and a positive electrode external terminal 9. The coil spring 10 can be compressed to release gas from the interior of the battery to the atmosphere when the internal pressure of the battery unusually increases.

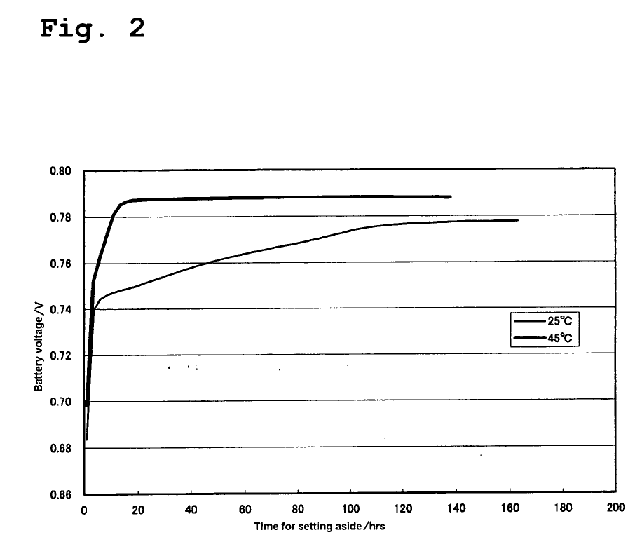

Alkaline storage batteries prepared in the above-described manner were set aside under temperature conditions of 25° C. and 45° C. to investigate changes in the battery voltage of the alkaline storage batteries. In FIG. 2, the thin line indicates the change in the battery voltage of an alkaline storage battery set aside at a temperature of 25° C., and the bold line indicates the change in battery voltage of the alkaline storage battery set aside at a temperature of 45° C. The results show that the maximum voltage of the alkaline storage battery that was set aside at 25° C. reached 0.778 V, and the maximum voltage of the battery that was set aside at 45° C. reached 0.788 V.

In Example 1, an alkaline storage battery fabricated in the above-described manner was set aside for 48 hours at a temperature of 25° C. After the battery was set aside for 48 hours at a temperature of 25° C., the battery voltage reached 0.760 V, and the difference (ΔV) from the maximum voltage 0.778 V of the battery set aside at 25° C. was 18 mV.

In Example 2, an alkaline storage battery fabricated in the above-described manner was set aside for 48 hours at a temperature of 45° C. After the battery was set aside for 48 hours at a temperature of 45° C., the battery voltage reached 0.788 V, which was the same voltage as the maximum voltage of the battery set aside at 45° C.; accordingly, the difference (ΔV) from the maximum voltage was 0 mV.

In Comparative Example 1, an alkaline storage battery fabricated in the above-described manner was set aside for 8 hours at a temperature of 25° C. After the battery was set aside for 8 hours at a temperature of 25° C., the battery voltage reached 0.752 V, and the difference (ΔV) from the maximum voltage 0.778 V of the battery set aside at 25° C. was 26 mV.

The respective alkaline storage batteries that had been set aside in the above-described manners were charged for 16 hours at a current of 150 mA, set aside for 1 hour, then discharged at a current of 300 mA to a battery voltage of 1.0 V, and thereafter set 5 aside for 1 hour to complete one charge-discharge cycle. This charge-discharge cycle was repeated three times to activate the alkaline storage batteries. Thus, respective alkaline storage batteries of Examples 1 and 2, and Comparative Example 1 were obtained.

Then, particles of the hydrogen-absorbing alloys were taken out from the negative electrodes of the alkaline storage batteries of Examples 1 and 2 and Comparative Example 1 that were activated in the above-described manner. After the hydrogen-absorbing alloy particles were washed and dried, the oxygen concentration (weight %) in a plurality of particles of each of the hydrogen-absorbing alloys at each of the distances set forth in Table 1 below from the surface was measured using a scanning Auger electron spectrometer (made by ULVAC-PHI, INC.: Model 670Xi) while the particles were etched at an etching rate of 80 Å/min on a SiO₂ basis using an argon ion gun. The averages of results obtained are shown in Table 1 below.

TABLE 1

| | | | Oxygen concentration at respective distances | | | | |
|---|---|---|---|---|---|---|---|
| | | | from surface after activation (weight %) | | | | |
| | Con- | ΔV | | | | | 1000 |
| | ditions | (mV) | 15 nm | 100 nm | 200 nm | 400 nm | nm |
| Ex. 1 | 25° C., | 18 | 33.15 | 30.01 | 14.14 | 2.25 | 0.27 |
| | 48 hrs | | | | | | |
| Ex. 2 | 45° C., | 0 | 24.83 | 23.55 | 20.39 | 7.21 | 0.34 |
| | 48 hrs | | | | | | |
| Comp. | 25° C., | 26 | 21.20 | 29.35 | 16.37 | 4.69 | 0.21 |
| Ex. 1 | 8 hrs | | | | | | |

Also, particles of each of the hydrogen-absorbing alloys taken out in the above-described manner were examined using the scanning Auger electron spectrometer to measure a lanthanum concentration L1 (weight %) at the surface (i.e., a region close to the surface) of the hydrogen-absorbing alloy particles and a minimum lanthanum concentration L2 (weight %) in a region of the hydrogen-absorbing alloy particles that is within 50 nm from the surface, and to obtain a L1/L2 value. The averages of results obtained from a plurality of measurements are shown in Table 2 below.

TABLE 2

| | | ΔV | L1 | L2 | |
|---|---|---|---|---|---|
| | Conditions | (mV) | (wt %) | (wt %) | L1/L2 |
| Ex. 1 | 25° C., 48 hrs | 18 | 11.4 | 6.0 | 1.90 |
| Ex. 2 | 45° C., 48 hrs | 0 | 8.6 | 4.5 | 1.91 |
| Comp. Ex. 1 | 25° C., 8 hrs | 26 | 4.2 | 2.9 | 1.45 |

The results show that in the hydrogen-absorbing alloys of Examples 1 and 2, the lanthanum concentration L1 at the surface of the hydrogen-absorbing alloy particles and the minimum lanthanum concentration L2 in a region within 50 nm from the surface satisfied the condition L1/L2≦1.9, whereas in the hydrogen-absorbing alloy particles of Comparative Example 1, the L1/L2 value was low.

Furthermore, particles of each of the hydrogen-absorbing alloys taken out in the above-described manner were examined using the scanning Auger electron spectrometer to measure a magnesium concentration M1 (weight %) in a region of the hydrogen-absorbing alloy particles within 30 nm from the surface (i.e., an average of plural measurements from the surface to 30 nm) and a magnesium concentration M2 (weight %) in an inner region of the particles that is deeper than 400 nm from the surface of the hydrogen-absorbing alloy particles, in which the oxygen concentration was less than 10 weight %, and to obtain a M1/M2 value. The results are shown in Table 3 below.

As a result, in the particles of each of the hydrogen-absorbing alloys of Examples 1 and 2, the magnesium concentration M1 in the region of the particles of the hydrogen-absorbing alloy powder that is within 30 nm from the surface was considerably less than the magnesium concentration M2 in the inner region of the hydrogen-absorbing alloy particles that is deeper than 400 nm from the surface, in which the oxygen concentration was less than 10 weight %; and their M1/M2 values were 0.18 or less. In contrast, in the particles of the hydrogen-absorbing alloy powder of Comparative Example 1, the magnesium concentration M2 in the inner region of the particles of the hydrogen-absorbing alloy powder that is deeper than 400 nm from the surface, in which the oxygen concentration was less than 10 weight %, was less than the magnesium concentration M1 in the region of the hydrogen-absorbing alloy particles within 30 nm from the surface; and M1/M2 value was 1.45. It is believed that this indicates that the magnesium in the inner region of the hydrogen-absorbing alloy particles is eluted therefrom because of the charge-discharge process for activating the alkaline storage battery.

Next, the alkaline storage batteries of Examples 1 and 2 and Comparative Example 1, activated in the above-described manner, were charged at a current of 1500 mA until the battery voltage reached the maximum value and then lessened by 10 mV therefrom, and were set aside for 1 hour. Thereafter, the batteries were discharged at a current of 1500 mA until the battery voltage reached 1.0 V, and they were set aside for 1 hour to complete one charge-discharge cycle. The discharge capacities at this point are shown in Table 2 below as their initial capacities. The foregoing charge-discharge cycle was repeatedly carried out to obtain the numbers of cycles until the discharge capacities decreased 60% of the initial capacities. The cycle numbers thus obtained are shown as cycle life in Table 3 below.

TABLE 3

| | | | | | | Initial | |
|---|---|---|---|---|---|---|---|
| | Con- | ΔV | M1 | M2 | | Capacity | Cycle |
| | ditions | (mV) | (wt %) | (wt %) | M1/M2 | (mAh) | life |
| Ex. 1 | 25° C., | 18 | 0.19 | 1.92 | 0.10 | 1467 | 560 |
| | 48 hrs | | | | | | |
| Ex. 2 | 45° C., | 0 | 0.33 | 1.79 | 0.18 | 1500 | 580 |
| | 48 hrs | | | | | | |
| Comp. | 25° C., | 26 | 0.43 | 0.30 | 1.45 | 1458 | 500 |
| Ex. 1 | 8 hrs | | | | | | |

As clearly seen from the results in Table 3, the alkaline storage batteries of Examples 1 and 2 showed remarkably improved cycle life over the alkaline storage battery of Comparative Example 1. The alkaline storage batteries of Examples 1 and 2 employed the hydrogen-absorbing alloy in which the magnesium concentration M1 in a region of the particles within 30 nm from the surface thereof was considerably lower than the magnesium concentration M2 in the inner region thereof deeper than 400 nm from the surface, in which the oxygen concentration was less than 10 weight %, and the M1/M2 value was 0.18 or less; on the other hand, the alkaline storage battery of Comparative Example 1 employed a hydrogen-absorbing alloy having a large M1/M2 value.

The above-described alkaline storage batteries of Example 2 and Comparative Example 1 underwent 150 cycles of the charge-discharge process in the above-described manner, and thereafter particles of the hydrogen-absorbing alloy powders in the negative electrodes were taken out. Each of the hydrogen-absorbing alloys was examined as described above, using a scanning Auger electron spectrometer to measure oxygen concentration (weight %) at respective distances from the surface of the hydrogen-absorbing alloy particles while performing etching using an argon ion gun at an etching rate of 80 Å/min. on a SiO₂ basis. The results of an average of a plural number of measurements are shown in Table 4 below.

TABLE 4

| | | | Oxygen concentration at respective distances | | | | |
|---|---|---|---|---|---|---|---|
| | | | from the surface after cycle 150 (weight %) | | | | |
| | Con- | ΔV | | | | | 1000 |
| | ditions | (mV) | 15 nm | 100 nm | 200 nm | 400 nm | nm |
| Ex. 2 | 45° C., | 0 | 48.86 | 32.49 | 13.18 | 3.13 | 0.90 |
| | 48 hrs | | | | | | |
| Comp. | 25° C., | 26 | 29.95 | 34.93 | 41.64 | 28.51 | 6.30 |
| Ex. 1 | 8 hrs | | | | | | |

The results show that in the alkaline storage battery of Comparative Example 1, the oxygen concentrations of the inner regions of the particles of the hydrogen-absorbing alloy powder that are at and deeper than 200 nm from the surface are considerably larger than those of the alkaline storage battery of Example 2. This indicates that in the alkaline storage battery of Comparative Example 1, oxidation of the hydrogen-absorbing alloy due to the charge-discharge process advanced further inside the particles than in the alkaline storage battery of Example 2.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2004-032982, filed Feb. 10, 2004, the disclosure of which is incorporated herein by reference.

1. A hydrogen-absorbing alloy for alkaline storage batteries, comprising a hydrogen-absorbing alloy powder containing at least a rare-earth element, magnesium, nickel, and aluminum; wherein the hydrogen-absorbing alloy powder has an intensity ratio I_{A}/I_{B} of 0.1 or greater in X-ray diffraction analysis using Cu—Kα radiation as an X-ray source, where I_{A} is a strongest peak intensity I_{A} that appears in the range of 2θ=31° to 33° and I_{B} is a strongest peak intensity that appears in the range of 2θ=40° to 44°; and wherein M1/M2 is equal to or less than 0.18, where M1 is a magnesium concentration in a region of particles of the hydrogen-absorbing alloy powder that is within 30 nm from the surface and M2 is a magnesium concentration in an inner region of the hydrogen-absorbing alloy particles where the oxygen concentration is 10 weight % or less.

2. The hydrogen-absorbing alloy for alkaline storage batteries according to claim 1, wherein the rare-earth element includes lanthanum, and a lanthanum concentration L1 at the surface of particles of the hydrogen-absorbing alloy powder and a minimum lanthanum concentration L2 in a region thereof within 50 nm from the surface satisfy the condition L1/L2≦1.9.

3. The hydrogen-absorbing alloy for alkaline storage batteries according to claim 1, wherein a crystal structure of the main phase of the alloy is a Ce₂Ni₇-type crystal structure.

4. The hydrogen-absorbing alloy for alkaline storage batteries according to claim 2, wherein a crystal structure of the main phase of the alloy is a Ce₂Ni₇-type crystal structure.

5. An alkaline storage battery comprising: a positive electrode employing nickel hydroxide, a negative electrode employing a hydrogen-absorbing alloy powder, and an alkaline electrolyte solution, wherein said negative electrode comprises a hydrogen-absorbing alloy powder containing at least a rare-earth element, magnesium, nickel, and aluminum, and having an intensity ratio I_{A}/I_{B} of 0.1 or greater in X-ray diffraction analysis using Cu—Kα radiation as an X-ray source, where I_{A} is a strongest peak intensity that appears in the range of 2θ=31° to 33° and I_{B} is a strongest peak intensity that appears in the range of 2θ=40° to 44°, and wherein, after activation of the alkaline storage battery, a condition M1/M2≦0.18 is satisfied, where M1 is the magnesium concentration in a region of particles of the hydrogen-absorbing alloy powder that is within 30 nm from the surface and M2 is the magnesium concentration in an inner region of the hydrogen-absorbing alloy particles where the oxygen concentration is 10 weight % or less.

6. The alkaline storage battery according to claim 5, wherein a main phase of the hydrogen-absorbing alloy has a Ce₂Ni₇-type crystal structure.

7. The alkaline storage battery according to claim 5, wherein said positive electrode comprises a nickel hydroxide, a surface of which is coated with a cobalt oxide in which the cobalt valence is higher than 2.

8. The alkaline storage battery according to claim 6, wherein said positive electrode comprises a nickel hydroxide, a surface of which is coated with a cobalt oxide in which the cobalt valence is higher than 2.

9. A method of manufacturing an alkaline storage battery including a positive electrode comprising nickel hydroxide, a negative electrode comprising a hydrogen-absorbing alloy powder, and an alkaline electrolyte solution, the method comprising:
using, as the hydrogen-absorbing alloy powder for the negative electrode, a hydrogen-absorbing alloy powder containing at least a rare-earth element, magnesium, nickel, and aluminum and having an intensity ratio I_{A}/I_{B} of 0.1 or greater in X-ray diffraction analysis using Cu—Kα radiation as an X-ray source, where I_{A} is a strongest peak intensity that appears in the range of 2θ=31° to 33° and I_{B} is a strongest peak intensity that appears in the range of 2θ=40° to 44°;
assembling the positive electrode, negative electrode and alkaline electrolyte solution to prepare the alkaline storage battery;
setting the alkaline storage battery aside until the battery voltage becomes equal to or above −18 mV with respect to the maximum voltage obtainable when setting the alkaline storage battery aside before initially charging the battery; and
activating the alkaline storage battery by charging and discharging the battery.

10. The method of manufacturing an alkaline storage battery according to claim 9, wherein, in setting the alkaline storage battery aside until the battery voltage becomes equal to or above −18 mV with respect to the maximum voltage obtainable when setting the alkaline storage battery aside before initially charging the battery, the alkaline storage battery is set aside at a temperature ranging from 25° C. to 80° C.
